(19) United States
(12) Patent Application Publication
(10) Pub. No.: US 2013/0332906 A1
(43) Pub. Date: Dec. 12, 2013

(54) CONCURRENT TEST GENERATION USING CONCOLIC MULTI-TRACE ANALYSIS

(71) Applicants: Niloofar Razavi, Princeton, NJ (US); Franjo Ivancic, Princeton, NJ (US); Vineet Kahlon, Princeton, NJ (US); Aarti Gupta, Princeton, NJ (US)

(72) Inventors: Niloofar Razavi, Princeton, NJ (US); Franjo Ivancic, Princeton, NJ (US); Vineet Kahlon, Princeton, NJ (US); Aarti Gupta, Princeton, NJ (US)

(21) Appl. No.: 13/874,702

(22) Filed: May 1, 2013

Related U.S. Application Data
(60) Provisional application No. 61/657,107, filed on Jun. 8, 2012.

(51) Int. Cl. G06F 11/36

(52) U.S. Cl. CPC G06F 11/3684; G06F 11/3688
USPC 717/124

(57) ABSTRACT

A method to test a concurrent program by performing a concolic multi-trace analysis (CMTA) to analyze the concurrent program by taking two or more test runs over many threads and generating a satisfiability modulo theory (SMT) formula to select alternate inputs, alternate schedules and parts of threads from one or more test runs; using an SMT solver on the SMT formula for generating a new concurrent test comprising input values, thread schedules and parts of thread selections; and executing the new concurrent test.

The present application is a non-provisional application of and claims priority to Provisional Application Ser. 61/657,107, filed Jun. 8, 2012, the content of which is incorporated by reference.

### BACKGROUND

This application relates to concurrent test generation techniques.

Given the omnipresence of software in today's society, there is a great need to develop technologies that target effective verification technologies for software. In industry, software testing and coverage-based metrics are still the predominant techniques to find correctness and performance issues in software systems. Recently, there has been extensive interest in both sequential test generation methods as well as predictive testing for concurrent programs.

In the past decade, there has been extensive interest in concolic execution for automatically generating tests to increase path coverage of sequential programs. These techniques combine symbolic execution for path exploration with powerful satisfiability modulo theory (SMT) solvers to compute inputs to previously unexplored branches or paths. To allow for a scalable and complete branch or path exploration, these techniques generally fall back upon concrete values observed during execution to handle non-linear computations or calls to external library functions, for which no good symbolic representation is available. The term concolic execution captures the combination of concrete and symbolic path exploration.

Discovering concurrency bugs is inherently hard due to the nondeterminism in multi-thread scheduling. One approach to discover concurrency bugs is based on systematic testing using stateless model checking. Another popular approach uses predictive analysis techniques. In predictive analysis, concurrency bugs are targeted by first observing multi-threaded execution traces on a given test input. Assume that the observed execution trace did not violate any embedded checks for concurrency issues, such as assertions, NULL pointer dereferences, deadlocks, or data races. Predictive analysis then tries to statically find a feasible permutation of the concurrent events of the observed trace, such that the permuted trace violates some property.

### SUMMARY

In one aspect, a method to test a concurrent program includes performing a concolic multi-trace analysis (CMTA) to analyze the concurrent program by taking two or more runs over many threads and generating a satisfiability modulo theory (SMT) formula to select inputs, schedules and parts of threads from one or more predetermined runs; using an SMT solver to find possible solutions to such an SMT formula thus generating specific input values, parts of thread selections and thread schedules; and executing the so created concurrent test runs.

Advantages of the preferred embodiments may include one or more of the following. The system increases structural code coverage for concurrent programs by generating new test inputs and thread schedules that are extensions/compositions of previously observed test runs. The system extends test input generation methods used in sequential programs with predictive analysis for the concurrent setting. For example, the system looks for uses (variable reads) of shared variables that lead to previously uncovered code parts, and then find appropriate definitions or defs (variable writes) in some other test runs that may feasibly be intertwined. The intertwining of multiple multi-threaded runs is formulated as an SMT problem, in a manner similar to concolic execution with predictive analysis to simultaneously consider alternate test inputs and thread schedules. Unlike previous extensions of concolic execution to concurrent programs based on global program structure, the instant approach targets branch coverage on the code of each individual thread, as this approach is more scalable. The search is guided by selection heuristics, providing a relatively complete predictive exploration in the limit (which should be avoided in practice). The resulting test generation tool can generate tests and schedules for concurrent programs and can successfully generate interesting tests, thus increasing structural code coverage. Other benefits include fast operation and low cost for improving structural test coverage. Due to the low cost and rapid analysis, the system can expose interesting concurrency issues/bugs. Since we generate test data inputs and thread schedules automatically, this can result in significant operational cost reduction in industrial practice. The system can automatically generate test inputs and thread execution schedules for concurrent programs that would allow it to increase structural code coverage of such concurrent programs. As discovering concurrency issues is inherently hard due to the non-determinism in concurrent thread scheduling, instead of trying to cover all possible thread schedules, the system focuses on the industrial practice of measuring structural code coverage, and design a methodology to automatically generate test input values and test schedules that would cover previously uncovered parts of the program.

### BRIEF DESCRIPTION OF THE DRAWINGS

FIG. 1 shows a high-level overview of a system to increase code coverage analysis.

FIG. 2 shows another embodiment of a test generator.

### DESCRIPTION

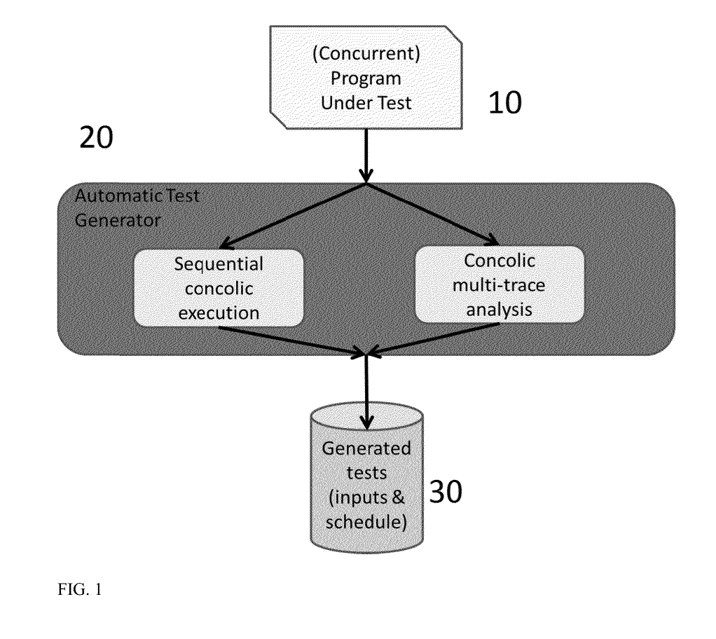

A concolic multi-trace analysis (CMTA) system that efficiently increases code coverage in concurrent programs is disclosed. FIG. 1 shows a high-level overview of a system to increase code coverage analysis. A concurrent program under test 10 is provided to an automatic test generator 20. For a given concurrent program, the system generates test inputs and thread schedules of interest. The system focuses on tests that increase the structural code coverage of the program under test. The automatic test generator utilizes two procedures to generate tests: one is a sequential concolic execution, and the other test allows concolic execution and predictive analysis of multiple test runs together called concolic multi-trace analysis (abbreviated CMTA). The result including generated tests (inputs and schedule) is stored in a database 30.

This system addresses the test generation problem for concurrent multi-threaded programs. The system addresses the generation of tests that will increase structural coverage of such programs. Thus, we are not necessarily interested in covering all possible thread interleavings unless this would increase structural coverage as well. However, having generated a set of relevant test inputs, it is always possible to perform a full predictive analysis as discussed above for each such test input. The system can use interesting def-use pairs, where a definition (def) represents a write of a shared variable in some thread, and a use represents a read of that variable in some other thread. The system can search over the space of such def-use pairs and exploits the fact that many different tests (inputs or schedules) may already be available or are easy to generate. By observing already available test runs for various writes to shared variables, the system can select parts of previously observed tests, and interject them into other tests to target previously unseen def-use pairs, thereby leading to new interesting concurrent program behaviors. In the following, previously observed multi-threaded execution fragments that end in a write to a shared variable are referred to as interlopers.

The system generates an interesting set of test inputs and thread schedules to start with, if none is provided; and efficiently searches for feasible interlopers that may result in new relevant def-use pairs. Branch coverage is provided. The system determines def-use pairs that lead to previously uncovered branches. Sequential test generation methods are used to generate inputs preventing context switching.

While sequential test generation methods are able to quickly cover large parts of the program sequentially even for concurrent programs, the system of FIG. 1 covers the remaining branches of the concurrent program (if they feasibly can be covered). Such branches that could not be covered purely sequentially are often due to interesting synchronizations. By focusing on such branches, the system only explores synchronization related branches. Once test inputs and test schedules for such branches are found, the system can perform a full predictive analysis in the style of CHESS, INSPECT or FUSION for these inputs, of course. Furthermore, it should be noted that such branches are generated by generating new test inputs and a new thread schedule by an appropriate SMT encoding and asking SMT solvers for solutions.

The system uses interloper executions to generate appropriate SMT queries. The system reasons and analyzes multiple test runs (each test run contains many threads), and merges the test runs so that a previously uncovered code portion becomes coverable. This is better than current predictive analysis techniques as implemented in CHESS, INSPECT, FUSION, and even TICK, which only reason about a single test run (over many threads).

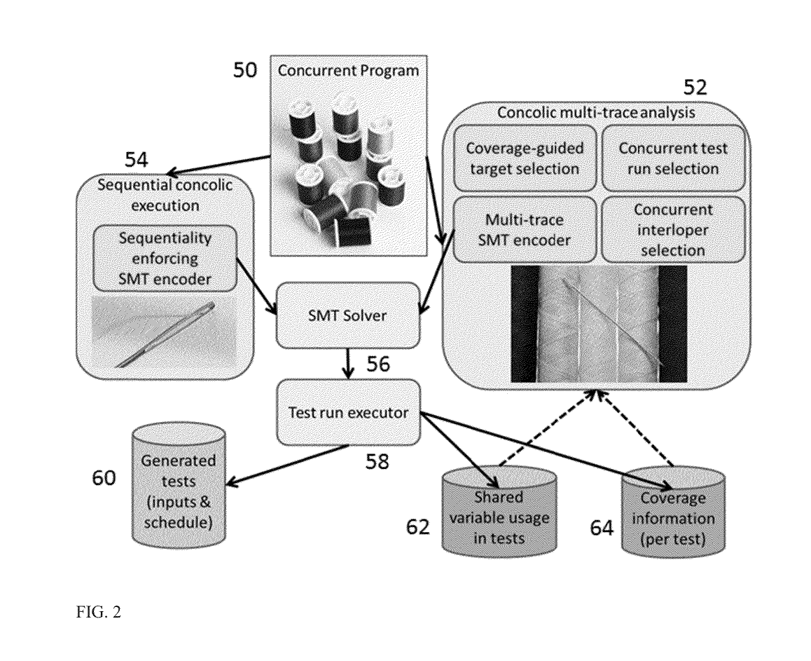

FIG. 2 shows another embodiment of a test generator. In FIG. 2, a concurrent program 50 is analyzed by a CMTA 52 which includes coverage-guided target selection, concurrent test run selection, multi-trace SMT encoder, and concurrent interloper selection. The output of the multi-trace analysis 52 is provided to an SMT solver 56. In parallel, the concurrent program 50 is analyzed by a sequential concolic execution with a sequentiality enforcing SMT encoder 54 and then provided to the SMT solver 56. A test run executor 58 outputs and stores generated tests (inputs and schedule) in database 60. The executor 58 also saves in database 62 the shared variable usage in tests and in database 64 coverage information per test. The CMTA determines how to generate appropriate SMT queries that would mix multiple test runs where each test run contains executions of a number of threads. The threads that are being executed in the different test runs that are being mixed can indeed overlap. Furthermore, in one test case a particular thread may execute a particular branch, whereas it may execute the other branch (of the conditional statement) in the other test run. CMTA generates an appropriated SMT query over such multiple test runs each containing many threads with a target branch of interest. A solution to this SMT query then provides a new test input to the program, a particular thread schedule, and which statements/branches of which test runs are preserved in the generated test.

To perform CMTA, the system requires each test run to record additional information to guide, for example, the selection of potential target branches of interest and the selection of test runs of interest (including an interloper test run). To do so, the databases 60-64 record information about which code structures are covered by the various test runs, which shared variables are written at various test runs, among others.

The system takes advantage of state-of-the-art sequential test generation methods that are generally able to quickly cover a large part of the program in terms of branches even for concurrent programs. Indeed, the branches of the concurrent program that are not covered using sequential methods alone are often due to interesting synchronizations between threads of the concurrent program that are worth exploring deeper. By focusing on such branches after all sequentially coverable branches are reached, the system able to explore synchronization related branches. Like predictive analysis, the system looks for alternate interleavings of observed events, but in multiple traces, not a single trace. Furthermore, the concolic approach generates alternate test inputs that can cover a branch or a target path. Thus, we try to cover branches or paths by generating appropriate SMT queries where the solver tries to find both a particular thread schedule and a required test input. Finally, note that in an active testing framework, many runtime bugs can be encoded as branches that are covered as part of structural code coverage.

The system uses sequential test generation methods as long as they are able to increase coverage on individual threads. In one embodiment, the concolic execution tool Crest is used as the test input generator. Upon coverage saturation, the system uses CMTA to generate new test inputs and thread schedules to cover previously uncovered branches in one of the threads. After generating new test inputs and thread schedules using CMTA, the system extends these new tests using sequential test generation again. This means, the system follows the generated test in terms of inputs and schedule up to the previously uncovered branch in some thread Tᵢ. Then, given that a new branch in thread Tᵢ was covered, the system tries to further explore potentially other previously uncovered parts of the program by exploring continuations of the test only along the thread Tᵢ, i.e. without allowing additional context switches.

CMTA is used to find a new thread schedule and new test inputs to cover a previously unreached branch. First, the system selects a target branch of interest, and corresponding traces that have been previously observed to come close to the target branch. Each previously observed trace has a given test input and thread schedule that it followed. The system also remembers for each test run which statements and branches in each thread are traversed, as well as the shared variables that are written to during the test. Assume that the uncovered branch depends on some set of shared variables S. Generally, the test condition may not be in terms of shared variables, but by intra-thread value tracing, the system can obtain S and then chooses candidate interloper trace segments from the set of so-far obtained traces, such that the interloper trace segments result in a shared variable state over S that satisfies the condition on the target branch. These interloper segments may contain executions of multiple threads. The system can apply filtering heuristics to choose an appropriate interloper segment to insert into one of the runs that came close to the target branch. Then, the system formulates an SMT problem that tries to find a viable test input and thread schedule of the modified original run, which also contains the chosen interloper segment.

The goal is to achieve high branch coverage on each thread. For that, the system first considers each thread separately and covers as many branches as possible using traditional concolic testing. Then, the system tries to cover the uncovered branches by the concurrent test generation technique. The intuition behind this approach is that many bugs in concurrent programs are sequential bugs that do not relate to any specific interleavings of concurrent execution of the programs. The idea is to catch those bugs by sequential testing, which is cheaper than concurrent testing, without requiring to consider the interleaving space. Then, concurrent test generation aims to cover the remaining uncovered branches by exploring the input space and the interleaving space simultaneously to find a combination that would cause the branch to be taken.

In order to perform sequential testing of a concurrent program, the system first executes the program with a set of random inputs, I, to obtain a concurrent trace of the program (represented by ρ). Then, the system focuses on sequential testing of each thread Tᵢ at a time. Based on the observed trace, the system generates a trace ρ′, which represents a sequential execution of Tᵢ, by enforcing a set of ordering constraints between the events of different threads in ρ. These constraints ensure that in ρ′: (1) thread Tᵢ is created, and (2) thread Tᵢ is executed sequentially and without any interference from other threads (if possible) after it is created until it is completed. To do so, the system generates happens-before relations on the events of ρ to enforce the schedule to be the same as ρ until thread Tᵢ is created, and then to enforce all of the events of other threads (after Tᵢ is created) to happen after the last event of Tᵢ. In cases where the complete sequential execution of Tᵢ is not possible due to some synchronization, the system uses corresponding orderings between the events of different threads in ρ to let Tᵢ complete.

For sequential testing of thread Tᵢ, the system applies traditional concolic testing starting with input set, I, and following the schedule implied by ρ′ until Tᵢ is completed. Traditional concolic testing then performs a DFS and collects a set of path constraints corresponding to the inner-most uncovered branch in Tᵢ. A satisfiable solution for these constraints provides a set of inputs for the next round in concolic testing.

Assume that there is a branch in thread Tᵢ which cannot be covered by sequential testing. Suppose that there is a run, represented by run, that hits the conditional statement corresponding to the uncovered branch. Also, suppose that x is a shared variable whose value affects the condition. The main idea of our concurrent test generation is to generate schedule/inputs in which the last write to x before the branch in run is overwritten by another write to x which will cause the branch to be taken. To that end, we find an interloper segment from a run (could be different from run), with a write to x, that could be “soundly” inserted after the last write to x in run and search for possible inputs that will cause the branch to be taken after the segment is inserted in run.

Next an exemplary process for concurrent test generation is discussed. The process gets as input a set of successful runs of the program, runSet, and a set branchSet of branches that are left uncovered during sequential testing. Initially, runSet mostly contains sequential runs, but over time it accumulates multi-threaded executions as well.

First, an uncovered branch is selected by selectBranch as the target to be covered. selectBranch uses heuristics to select a branch, e.g. the depth of the branch in the CFG, number of failures in targeting to cover the branch, etc. Then, for the selected branch, the process picks a set of runs (runChoices) from runSet that hit the branch condition. Obviously, the branch condition is false in all of these runs. In lines 3-17, the process iterates over the runs in runChoices until the process finds an appropriate segment and corresponding inputs that would likely cause the branch to be taken after the segment is inserted in the run. At line 4, the process picks a run run from runChoices and then find the set aVarSet of shared variables whose values affect the branch condition by performing a traditional def-use analysis on run. In lines 6-17, the system analyzes these variables to find a segment containing a write to the selected variable that can be inserted after the last write to the variable in run. For an affecting variable aVar, let <w,r> be a pair of write/read events where w represents the last write event to aVar before the branch and r represents the read event reading the value of aVar just before the branch in run. In fact, the write to aVar in the segment can be inserted anywhere between w and r in run. The pseudo-code is as follows:

concurrentTestGeneration (branchSet, runSet) begin

| | |
|---|---|
| 1: | br = selectBranch (branchSet) |
| 2: | runChoices = subset of runs in runSet that bit br |
| 3: | bool found = false |
| 4: | while (! found && runChoices ≠ 0) do |
| 5: | run = extract a run from runChoices |
| 6: | affectingVarSet = set of variables whose value affect the condition of br in run |
| 7: | while (! found && affectingVarSet ≠ 0) do |
| 8: | affectingVar = extract an affecting variable from affectingVarSet |
| 9: | < w,r > = last write/read of affectingVar in run just before br |
| 10: | foreach event e such that w < e < r do |
| 11: | gLoc = global location in run at e |
| 12: | segmentSet = findInterloperSegments (gLoc, affectingVar, runSet) |
| 13: | while (! found && segmentSet ≠ 0) do |
| 14: | interloperSegment = extract a segment from segmentSet |
| 15: | constraints = multiTraceAnalysis (run, br, r, interloperSegment, gLoc) |
| 16: | call SMT solver to generate input/schedule for constraints |
| 17: | if (input/schedule found) then |
| 18: | found = true |
| 19: | end if |
| 20: | end for |
| 21: | end for |
| 22: | end while |
| 23: | end while |

end

The interloper segments should be selected in such a way that they could be inserted soundly in run. At a minimum, threads executing in the segment should be at the same locations as they are at the insertion point in run. The system defines a global location as a tuple <loc₁, loc₂, . . . > where locᵢ is the location of thread Tᵢ. Recall that a location contains both the statement identifier as well as an instance identifier. Given a run, the global location can be computed at each point by looking at the last event of each thread in the run before that point. In lines 9-17, the process go over the global locations at an event e, such that w<e<r, where < represents the order of the events in run, and try to find an appropriate set of interloper candidates. Given a global location gLoc, an affecting variable aVar, and a set of runs runSet, algorithm findInterloperSegments returns a set of segments from runSet that can be inserted soundly (and not necessarily atomically) at any point with global location gLoc. All segments end with a write to the shared variable aVar. In lines 12-17, the process goes over the interloper segments and calls the multi-trace predictive analysis engine which encodes the set of all feasible runs of the program that result from inserting a specific segment at gLoc in run as a set of constraints. Then, an SMT solver is used over the concolic execution to search for inputs and a schedule that would cause the branch to be taken. If such inputs/schedule exist, then the process stops the search and executes the program with the found inputs according to the corresponding schedule which guarantees the branch to be taken.

The process for finding the interloper is discussed next. The process for finding interlopers from a set of given runs runSet is based on a global location gLoc and an affecting variable aVar. The set of all runs is analyzed in which there is at least one write to aVar (line 2). For each run, the process iterates over the set of writes to aVar and finds candidate segments containing a write as their last event while starting at a global location consistent with gLoc. To that end, for a selected write to aVar, the process performs a static backward analysis in the corresponding run, until we reach a gLoc-consistent location. Some threads may be active in the run without causally affecting the write to aVar. Requiring the location of such threads to match with gLoc is too restrictive and could miss useful segments. Therefore, as the process goes backward in the run, the process adds events to the segment only if the selected write is causally dependent on the event. The process keeps track of the threads corresponding to such events, represented by threadSet. At each location loc in the run, the process checks whether the projection of global location loc to the threads in threadSet is equal to the projection of global location gLoc to this set of threads; i.e. gLoc|_{threadSet}=loc|_{threadSet}. If this check passes, the segment is added to the candidate segment set. The pseudo-code is as follows:

findInterloperSegment (gLoc, affectingVar, runSet) begin

| | |
|---|---|
| 1: | segmentSet = 0 |
| 2: | runChoices = set of runs in runSet that write of affectingVar |
| 3: | while (runChoices ≠ 0) do |
| 4: | run = extract a run from runChoices |
| 5: | candidateWrites = set of all writes to affectingVar in run |
| 6: | foreach (w ε candidateWrites) do |
| 7: | segment = 0 |
| 8: | segment.push(w) |
| 9: | loc = global location in run at w |
| 10: | threndSet = w.tId |
| 11: | event = w |
| 12: | while (gLoc\|_{threadSet} ≠ Loc\|_{threadSet} && event is not the |
| | first event in run) do |
| 13: | event = previous event of event in run |
| 14: | loc = global location in run at event |
| 15: | if (w causally depends on event) then |
| 16: | segment.push(event) |
| 17: | threadSet = threadSet ∪ event.tId |
| 18: | end if |
| 19: | end while |
| 20: | if (gLoc\|_{threadSet} = loc\|_{threadSet}) then |
| 21: | segmetSet = segmentSet ∪ segment |
| 22: | end if |
| 23: | end for |
| 24: | end do |
| 25: | return segmentSet; |

end

Next, a Multi-Trace Predictive Analysis with Input Generation process is discussed. Given a run run, containing an uncovered branch br with the affecting read r, an interloper segment seg with a candidate write w, and a global location gLoc in run representing the insertion point, the process symbolically encodes a set of feasible runs, in which the schedule is the same as in run until reaching gLoc and then the interloper segment is inserted (not necessarily atomically) at gLoc in a way that r is guaranteed to read the value written by w. The inputs of the program are treated symbolically allowing SMT solvers to simultaneously search for inputs and a schedule that would cause br to be taken. The event sequence in run is called before the insertion point the prefix segment and the events after the insertion point and before br the main segment.

CMTA is based on the CTPs of the main and the interloper segments, which already represent program inputs symbolically. Let CTPₘₐᵢₙ and CTPᵢₙₜ denote the CTPs of the main and interloper segments, respectively. The process ensures that the location of each thread in the interloper segment is the same at the beginning of both segments. Therefore, threads in the interloper segment should have a maximum common prefix of locations in both CTPₘₐᵢₙ and

$${de}_{{T}_{i}}^{main} . loc \neq {de}_{{T}_{i}}^{int} . loc ,$$

The threads may then diverge after this prefix in the segments. To avoid duplication when inserting the interloper segment in the main segment, it should be ensured that each thread is at each location at most once in the predicted run. Let

$${CTP}_{int} ; i . e . ∀ {T}_{i } in {CTP}_{int} ∃ k : {∀}_{j \leq k} j {CTP}_{main} {{\vert}_{{T}_{i}} [ j ] . loc = {CTP}_{int} \vert}_{{T}_{i}} [ j ] . loc .$$

represent the first event of thread Tᵢ in CTPₘₐᵢₙ and CTPᵢₙₜ at which

$${de}_{{T}_{i}}^{main} and {de}_{{T}_{i}}^{int}$$

respectively. Since the segments diverge after de_{Ti}^{main} and de_{Ti}^{int}, this means that for each thread after this point we should consider events either from the main segment or from the interloper segment. This will be enforced using indicator bits (see below, item 6).

Suppose that E^{main} and E^{int} represent the set of events in the main and interloper segments, respectively. Note that not all of these events may be required for prediction. Indeed, certain events may be inconsistent with each other, if they originated from diverging runs. Therefore, for each event eᵢεE^{main}∪E^{int} the process considers an indicator bit bₑ_{ᵢ} whose value determines whether the event is required to happen before the branch in the predicted run or not. Based on the given run and an interloper segment, a formula Φ_{MCTP} is built such that Φ_{MCTP} is satisfiable if there exist inputs/schedule that would cause br to be taken, where the schedule follows the prefix segment and then interleaves the execution of threads in the main and interloper segments.

A procedure can insert an interloper segment with the goal of forcing the execution of a target branch br. Towards that end, the process includes identifying a tuple of the form [symbol] w,r [symbol] , where w and r are the last write and read events, respectively, for variable affecting the valuation of br. In general, however, to cover all partial orders induced by shared variable accesses in different threads, the process can explore a potential insertion of interlopers between each tuple [symbol] w′,r′ [symbol] , where w′ and r′ are the definition and use, respectively, of a shared variable sh, say, occurring along a def-use chain leading to a variable impacting the valuation of br. This is because any change to the value of sh between events w′ and r′ propagates to br potentially affecting it.

Motivated by the above discussion, let Tup be the set of all tuples of the form [symbol] w′,r′ [symbol] , where w′ and r′ are the definition and use, respectively, of a shared variable occurring along a def-use chain leading to a variable impacting the valuation of br. The test generation algorithm can be updated as follows. The process can add an outer loop that enumerates each subset Tup′ of Tup. Then, as discussed above, each def-use tuple in this subset is a candidate for interloper insertion. This is accomplished by identifying an event eₜᵤₚ for each tupεTup′ where an interloper can be inserted. As before the interloper can be identified via a call to findInterloperSegments. The constraints for the SMT solver need to be modified to ensure consistency for the simultaneous insertion of all |Tup′| interlopers. This modification will explore only those partial orders that are generated by shared variable accesses occurring in the set of runs runSet. This is why this procedure only guarantees relative completeness, i.e., with respect to the set runSet. This is similar to other predictive and concolic techniques that are biased towards observed test runs. In general, the dynamic tests can be supplemented by static analysis. However, in the limit, this procedure may not scale due to an explosion in the number of runs that may be generated. It is contemplated that prioritization schemes over the set of interleavings can be used in order to excite a given branch.

Based on the given run (including the prefix and main segments) and an interloper segment. a formula Φ_{MCTP} is built such that Φ_{MCTP} is satisfiable if there exists inputs/schedule which would cause br to be taken and the schedule follows the prefix segment and then interleaves the execution of threads in the main and interloper segments

Φ_{MCTP}=Φ_{MCTP}^{FP} [symbol] Φ_{MCTP}^{PO} [symbol] Φ_{MCTP}^{ST} [symbol] Φ_{MCTP}^{π} [symbol] Φ_{MCTP}^{BR} [symbol] Φ_{MCTP}^{AWR} [symbol] Φ_{MCTP}^{ind}

is constructed as follows (Φ_{MCTP}^{FP}=Φ_{MCTP}^{π}=Φ_{MCTP}^{ind}=true initially).
Fixed Prefix: For each event εᵢ in the prefix segment:
   if eᵢ is the first event in run, do nothing. Otherwise, Φ_{MCTP}^{FP}=Φ_{MCTP}^{FP} [symbol] HB(e′ᵢ, eᵢ) where e′ᵢ is the predecessor of eᵢ in the prefix segment. This keeps the order of events the same as in the prefix segment.
   if the corresponding statement of eᵢ has lval:=exp, let Φ_{MCTP}^{FP}=Φ_{MCTP}^{FP} [symbol] g(eᵢ) [symbol] (lval=exp). If eᵢ contains assert(c), let Φ_{MCTP}^{FP}=Φ_{MCTP}^{FP} [symbol] g(eᵢ) [symbol] (g(eᵢ)→c). Note that g(eᵢ) is required to be true in any case.
Inserting Interloper Segment in Suffix:
   1. Program Order: Φ_{MCTP}^{PO}=Φ_{CTP}_{ₘₐᵢₙ}^{PO} [symbol] Φ_{CTP}_{ᵢₙₜ}^{PO}.
   2. Statements: Φ_{MCTP}^{ST}=Φ_{CTP}_{ₘₐᵢₙ}^{ST} [symbol] Φ_{CTP}_{ᵢₙₜ}^{ST}.
   3. π-Functions: Define a new x-function for each shared variable use in E^{main}∪E^{int}−{r} to include definitions in both run and the interloper segment. Then, for each w←π(υ₁, . . . , υₖ), defined in eεE^{main}∪E^{int}−{r}, let eᵢ be the event that defines υᵢ, let Φ_{MCTP}^{π}=Φ_{MCTP}^{π} [symbol] ᵢ₌₁^{k}[(w=υᵢ) [symbol] g(eᵢ) [symbol] HB(eᵢ,e) [symbol] _{j=1,j≠i}^{k}(HB(eⱼ,eᵢ) [symbol] HB(e,eⱼ))].
   4. Branch: Suppose that (assume(c), 0) is the uncovered branch statement. In fact, the branch event e_{br} in run relates to a statement (assume( [symbol] c), 0) representing the other branch of the corresponding conditional statement. Let Φ_{MCTP}^{BR}=g(e_{br})=c [symbol] g(e′) where e′ is the predecessor of e_{br}.
   5. Affecting Write/Read Matching: Let W_{affectingVar} represent all the write events to affectingVar in E^{main}∪E^{int}. Then Φ_{MCTP}^{AWR}=HB(w,r) [symbol] [symbol] eᵢεW_{affectingVar} (HB(eᵢ, r) [symbol] HB(w, eᵢ)).
   6. Indicators: For each event eᵢ in E^{main}∪E^{int}

$${Φ}_{MCTP}^{Ind} := {Φ}_{MCTP}^{Ind} ( {b}_{{e}_{i}} -> g ( {e}_{i} ) ) ( {b}_{{e}_{i}} -> HB ( {e}_{i} , {e}_{br} ) ) ( ( {b}_{{e}_{i}} ) -> HB ( {e}_{br} , {e}_{i} ) )$$

If eᵢ belongs to read Tᵢ, let eⱼ be the predecessor of eᵢ in Tᵢ. Then, Φ_{CTP}^{ind}=Φ_{CTP}^{ind} [symbol] (bₑ_{ᵢ}→bₑ_{ⱼ})
For each active thread Tᵢ in the interloper segment:

$${Φ}_{MCTP}^{Ind} = {Φ}_{MCTP}^{Ind} ( {b}_{{de}_{{T}_{i}}^{main}} -> ( {b}_{{de}_{{T}_{i}}^{int}} ) ) ( {b}_{{de}_{{T}_{i}}^{int}} -> ( {b}_{{de}_{{T}_{i}}^{main}} ) ) .$$

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to test a concurrent program, comprising:
performing a concolic multi-trace analysis (CMTA) to analyze the concurrent program by taking two or more test runs over many threads and generating a satisfiability modulo theory (SMT) formula to select alternate inputs, alternate schedules and parts of threads from one or more test runs;
using an SMT solver on the SMT formula for generating a new concurrent test comprising input values, thread schedules and parts of thread selections; and
executing the new concurrent test.

2. The method of claim 1, comprising iterating until a predetermined stopping criterion is met.

3. The method of claim 1, wherein the CMTA comprises coverage guided target selection.

4. The method of claim 1, wherein the CMTA comprises test run selection.

6. The method of claim 1, comprising selecting a concurrent interloper, where the interloper comprises a part of a thread from a different test run to interleave within a chosen thread.

7. The method of claim 6, wherein the concurrent interloper selection is based on determining which shared variables and values are read or written in different threads.

8. The method of claim 1, comprising storing generated tests, shared variable usage in tests, and coverage information per test for CMTA and concolic execution analysis.

9. The method of claim 1, wherein one or more test runs are generated using a sequential concolic execution.

10. The method claim 9, wherein the sequential concolic execution includes a sequentiality enforcing SMT encoder.

11. The method of claim 9, comprising sequential concolic execution for concurrent programs by enforcing sequentiality of a given target thread execution.

12. The method of claim 1, comprising selecting target branches, target runs, and interloper segments to interleave.

13. A system to test a concurrent program, comprising:
a concolic multi-trace analyzer (CMTA) to analyze the concurrent program by taking two or more test runs over many threads and generating a satisfiability modulo theory (SMT) formula to select alternate inputs, alternate schedules and parts of threads from one or more test runs;
an SMT solver to receive the SMT formula for generating a new concurrent test comprising input values, thread schedules and parts of thread selections; and
a test run execution engine coupled to the SMT solver.

14. The system of claim 13, comprising code for iterating until a predetermined stopping criterion is met.

15. The system of claim 13, wherein the CMTA comprises coverage guided target selection.

16. The system of claim 13, wherein the CMTA comprises test run selection.

17. The system of claim 13, wherein the CMTA comprises a selector for concurrent interloper selection, where the interloper comprises a part of a thread from a different test run to interleave within a chosen thread.

18. The system of claim 17, wherein the concurrent interloper selection is based on determining which shared variables and values are read or written in different threads.

19. The system of claim 13, comprising code for storing generated tests, shared variable usage in tests, and coverage information per test for CMTA and concolic execution analysis.

20. The system of claim 13, wherein one or more test runs are generated using a sequential concolic execution.
